(19) United States
(12) Patent Application Publication
(10) Pub. No.: US 2023/0399237 A1
(43) Pub. Date: Dec. 14, 2023

(54) Y-TYPE HEXAFERRITE, METHOD OF MANUFACTURE, AND USES THEREOF

(71) Applicant: ROGERS CORPORATION, Chandler, AZ (US)

(72) Inventors: Yajie Chen, Andover, MA (US); Lance Young, Shrewsbury, MA (US); Allen F. Horn, III, Pomfret Center, CT (US); William Blasius, Charlton, MA (US); Lori Brock, Ipswich, MA (US)

(21) Appl. No.: 18/205,007

(22) Filed: Jun. 2, 2023

Related U.S. Application Data
(60) Provisional application No. 63/350,248, filed on Jun. 8, 2022.

(51) Int. Cl. C01G 49/00; C08K 3/22

(52) U.S. Cl. CPC C01G 49/0054; C08K 3/22; C01P 2004/61; C08K 2003/2265; C01P 2006/42

(57) ABSTRACT

In an aspect, a Co₂Y-type ferrite includes oxides of at least Ba, La, Co, Me, Fe, and optionally Ca; wherein Me is at least Ni and optionally one or more of Zn, Cu, Mn, or Mg. A composite can include the Co₂Y-type ferrite and a polymer. An article can include the Co₂Y-type ferrite.

### CROSS REFERENCE TO RELATED APPLICATIONS

This application claims the benefit of U.S. Provisional Application Ser. No. 63/350,248, filed Jun. 8, 2022, which is incorporated herein by reference in its entirety.

### BACKGROUND

The disclosure is directed to a Y-type hexaferrite comprising lanthanum and nickel.

Improved performance and miniaturization are needed to meet the ever-increasing demands of devices used in very high frequency applications, which are of particular interest in a variety of commercial and defense related industries. As an important component in radar and Global Positioning System (GPS) navigation systems, antenna elements with compact sizes are constantly being developed. It has been challenging however to develop ferrite materials for use in such high frequency applications as most ferrite materials exhibit relatively high magnetic loss at high frequencies.

In general, hexagonal ferrites, or hexaferrites, are a type of iron-oxide ceramic compound that has a hexagonal crystal structure and exhibits magnetic properties. Several types of families of hexaferrites are known, including Z-type ferrites, Ba₃Me₂Fe₂₄O₄₁, and Y-type ferrites, Ba₂Me₂Fe₁₂O₂₂, where Me can be a small 2+cation such as Co or Zn, and Sr can be substituted for Ba. Other hexaferrite types include M-type ferrites ((Ba,Sr)Fe₁₂O₁₉), W-type ferrites ((Ba,Sr)Me₂Fe₁₆O₂₇), X-type ferrites ((Ba,Sr)₂Me₂Fe₂₈O₄₆), and U-type ferrites ((Ba,Sr)₄Me₂Fe₃₆O₆₀).

Hexaferrites with a high magnetocrystalline anisotropy field are good candidates for gigahertz antenna substrates because they have a high magnetocrystalline anisotropy field and thereby a high ferromagnetic resonance frequency. Improved ferrites though with low loss values around one gigahertz are desirable.

### BRIEF SUMMARY

Disclosed herein is a Co₂Y-type hexaferrite.

In an aspect, a Co₂Y-type ferrite includes oxides of at least Ba, La, Co, Me, Fe, and optionally Ca; wherein Me is at least Ni and optionally one or more of Zn, Cu, Mn, or Mg.

In another aspect, a composite includes the Co₂Y-type ferrite and a polymer.

In yet another aspect, an article can include the Co₂Y-type ferrite.

In a further aspect, a method of making the Co₂Y-type ferrite comprises milling ferrite precursor compounds comprising oxides of at least Ba, La, Co, Me, and Fe, wherein Me includes Ni and optionally another divalent element such as one or more of Zn, Cu, Mn, or Mg to form a magnetic oxide mixture; and calcining the magnetic oxide mixture in an oxygen or air atmosphere to form the Co₂Y-type ferrite.

The above described and other features are exemplified by the following detailed description and claims.

### BRIEF DESCRIPTION OF THE DRAWINGS

The following Figures are exemplary embodiments, which are provided to illustrate the present disclosure. The figures are illustrative of the examples, which are not intended to limit devices made in accordance with the disclosure to the materials, conditions, or process parameters set forth herein.

FIG. 1 is a graphical illustration of the permeability and magnetic loss of at different frequencies for Examples 1-3;

FIG. 2 is a graphical illustration of the permittivity and dielectric loss at different frequencies for Examples 1-3;

FIG. 3 is a graphical illustration of the permeability and magnetic loss of at different frequencies for Example 4; and

FIG. 4 is a graphical illustration of the permittivity and dielectric loss at different frequencies for Example 4.

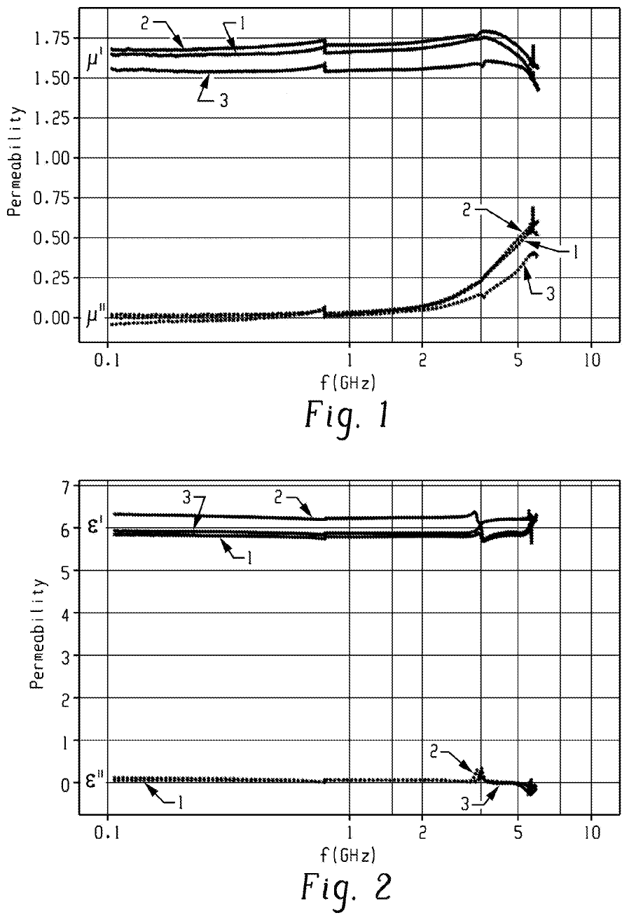

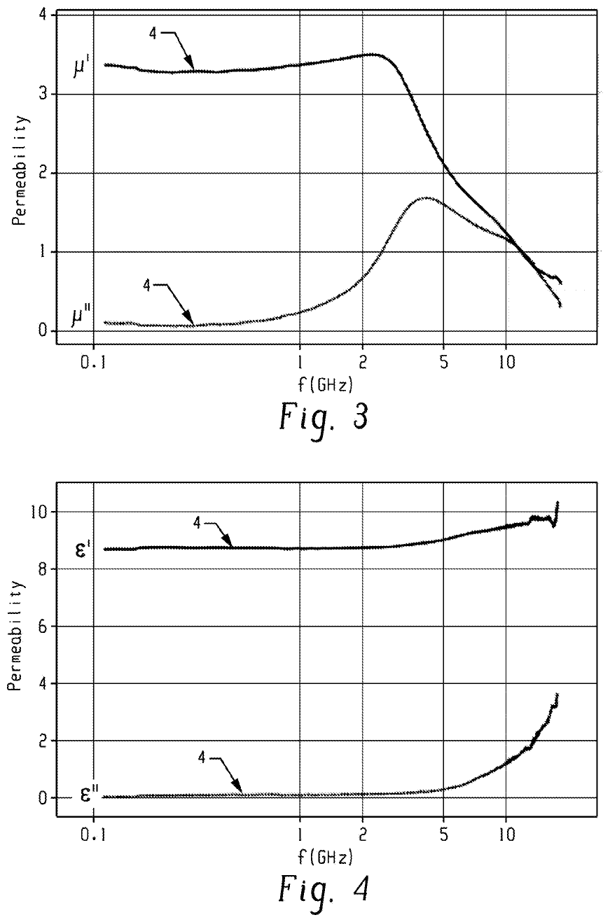

### DETAILED DESCRIPTION

It was discovered that a Co₂Y-type ferrite comprising both lanthanum and nickel displays a very low loss over the frequencies of 1 to 2 gigahertz (GHz) that is difficult to achieve with Y-type ferrites. For example, it was found that the Co₂Y-type ferrite can have a specific magnetic loss of less than or equal to 0.02, or less than or equal to 0.03, or less than or equal to 0.015, or 0.012 to 0.03 over the frequency range of 1 to 2 GHz or at 1.2 GHz. The Co₂Y-type ferrite comprises oxides of at least Ba, La, Co, Me, Fe, and optionally Ca; wherein Me is at least Ni and optionally one or more of Zn, Cu, Mn, or Mg. The Co₂Y-type ferrite can have the formula (1) or formula (2).

Ba₁₋ₓLaₓCaₙCo_{2-y-z}Me_{y}Fe₁₂₋ₘO₂₂ (1)

Ba₁₋ₓLaₓCaₙCo_{2-y-z}Ni_{y}Fe₁₂₋ₘO₂₂ (2)

Me includes Ni and optionally one or more of Zn, Cu, Mn, or Mg. The variable x can be 0.01 to 0.5, or 0.4 to 0.5. The variable y can be 0.01 to 1.5, or 0.1 to 1, or 0.2 to 0.5. The variable z can be −0.5 to 0.5, or −0.2 to 0. The variable m can be −2 to 2, or 0.1 to 0.5. The variable n can be 0 to 0.5.

The Co₂Y-type ferrite can be in the form of particulates (for example, having a spherical or irregular shape) or in the form of platelets, whiskers, flakes, etc. A D₅₀ particle size by volume of the particulate Co₂Y-type ferrite can be 0.5 to 50 micrometers, or 0.5 to 20 micrometers, or 1 to 10 micrometers, or 0.1 to 1 micrometer. The Co₂Y-type ferrite can have an average particle size is of 0.5 to 50 micrometers, or 0.5 to 20 micrometers, or 1 to 10 micrometers as measured using scanning electron microscopy. Platelets of the Co₂Y-type ferrite can have an average maximum length of 0.1 to 100 micrometers and an average thickness of 0.05 to 1 micrometer. The Co₂Y-type ferrite can have a porosity of 0 to 50 volume percent (vol %), or 20 to 45 volume percent based on the total volume of the Co₂Y-type ferrite.

The Co₂Y-type ferrite can be formed by mixing the precursor compounds including oxides of at least Ba, La, Co, Me, Fe, and optionally Ca, wherein Me includes Ni and optionally another divalent element such as one or more of Zn, Cu, Mn, or Mg to form a magnetic oxide mixture, and calcining the magnetic oxide mixture in an oxygen or air atmosphere to form the Co₂Y-type ferrite. The resultant Co₂Y-type ferrite can have the formula (1) or (2). Examples of the oxides can include BaCO₃, CaCO₃, Co₃O₄, Fe₂O₃, La₂O₃, NiO, MgO, ZnO, and CuO.

The Co₂Y-type ferrite can be calcined. The calcining can occur at a calcining temperature of 800 to 1,300° C., or 800 to 1,280° C., or 900 to 1,250° C. The calcining can occur for a calcining time of 0.5 to 20 hours, or 1 to 10 hours. The ramping rate of the calcining step is not particularly limited and can occur at a ramping and cooling rate of 1 to 5 degrees Celsius per minute (° C./min), or 2 to 4° C./min. The calcining can occur in air or in an oxygen environment, for example, under a flow of oxygen at a flow rate of 0.1 to 10 liters per minute. The calcining step can be the only heating step used in making the Co₂Y-type ferrite.

After the calcining step, the calcined ferrite can be ground and screened to form coarse particles. The coarse particles can be ground to a D₅₀ particle size by volume of 0.1 to 20 micrometers, or 0.5 to 20 micrometers, or 1 to 10 micrometers, or 0.1 to 1 micrometer.

The Co₂Y-type ferrite can be milled. The milling can occur for a milling time of greater than or equal to 1 to 10 minutes, or 5 to 60 minutes, or 1 minute to 10 hours. The milling can occur at a mixing speed of greater than or equal to 300 revolutions per minute (rpm), or 300 to 1,000 rpm, or less than or equal to 600 rpm, or 400 to 500 rpm. The milling can occur in a wet-planetary ball mill. The milled mixture can optionally be screened, for example, using a 10 to 300# sieve. The milled mixture can be mixed with a polymer such as poly(vinyl alcohol) to form granules. The granules can have an average D₅₀ particle size by volume of 50 to 300 micrometers. The milled mixture can be shaped or formed, for example, by compressing at a pressure of 0.2 to 2 megatons per centimeter squared. The milled mixture, either particulate or formed, can be heated at a temperature of 50 to 500° C., 200 to 1,280° C., or 100 to 250° C. The milled mixture, either particulate or formed, can be post-annealed at an annealing temperature of 900 to 1,275° C., or 1,200 to 1,250° C. The heating or annealing can occur for 1 to 20 hours, or 4 to 6 hours, or 5 to 12 hours. The annealing can occur in air or oxygen.

The Co₂ Y-type ferrite can comprise a surface coating. The coating can allow for an increased amount of the Co₂Y-type ferrite in a composite. The coating can be a hydrophobic coating. The coating can comprise at least one of a silane coating, a titanate coating, or a zirconate coating.

The silane coating can be formed from a silane, which can comprise at least one of a linear silane, a branched silane, or a cyclosilane. The silane can comprise a precipitated silane. The silane can be free of a solvent (such as toluene) or a dispersed silane, for example, the silane can comprise 0 to 2 weight percent (wt %) (for example, 0 wt %) of a solvent dispersed silane based on the total weight of the silane.

A variety of different silanes can be used to form the coating, including one or both of a phenylsilane and a fluorosilane. The phenylsilane can be p-chloromethyl phenyl trimethoxy silane, phenyl trimethoxy silane, phenyl triethoxy silane, phenyl trichlorosilane, phenyl-tris-(4-biphenylyl) silane, hexaphenyldisilane, tetrakis-(4-biphenylyl)silane, tetra-Z-thienylsilane, phenyltri-Z-thienylsilane, 3-pyridyltriphenylsilane, or a combination comprising at least one of the foregoing. Functionalized phenylsilanes as described in U.S. Pat. No. 4,756,971 can also be used, for example, functional phenylsilanes of the formula R′SiZ¹ R²Z² wherein R′ is alkyl with 1 to 3 carbon atoms. —SH, —CN, —N₃ or hydrogen; Z¹ and Z² are each independently chlorine, fluorine, bromine, alkoxy with not more than 6 carbon atoms, NH, —NH₂, -NR₂′; and R² is

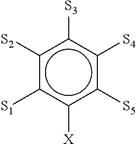

wherein each of the S-substituents, S₁, S₂, S₃, S₄ and S₅ are independently hydrogen, alkyl with 1 to 4 carbon atoms, methoxy, ethoxy, or cyano, provided that at least one of the S-substituents is other than hydrogen, and when there is a methyl or methoxy S-substituent, then (i) at least two of the S-substituents are other than hydrogen, (ii) two adjacent S-substituents form with the phenyl nucleus a naphthalene or anthracene group, or (iii) three adjacent S-substituents form together with the phenyl nucleus a pyrene group, and X is the group —(CH₂)ₙ—, wherein n is 0 to 20, specifically, 10 to 16 when n is not 0, in other words X is an optional spacer group, the S-substituents. The term “lower” in connection with groups or compounds, means 1 to 7, or 1 to 4 carbon atoms.

The fluorosilane coating can be formed from a perfluorinated alkyl silane having the formula: CF₃(CF₂)ₙ—CH₂CH₂SiX, wherein X is a hydrolyzable functional group and n=0 or a whole integer. The fluorosilane can comprise at least one of (3,3,3-trifluoropropyl)trichlorosilane, (3,3,3-trifluoropropyl)dimethylchlorosilane, (3,3,3-trifluoropropyl)methyldichlorosilane, (3,3,3-trifluoropropyl)methyldimethoxysilane, (tridecafluoro-1,1,2,2-tetrahydrooctyl)-1-trichlorosilane, (tridecafluoro-1,1,2,2-tetrahydrooctyl)-1-methyldichlorosilane, (tridecafluoro-1,1,2,2-tetrahydrooctyl)-1-dimethylchlorosilane, (heptadecafluoro-1,1,2,2-tetrahydrodecyl)-1-methyldichlorosilane, (heptadecafluoro-1,1,2,2-tetrahydrodecyl)-1-trichlorosilane, heptadecafluoro-1,1,2,2-tetrahydrodecyl)-1-dimethylchlorosilane, (heptafluoroisopropoxy) propylmethyldichlorosilane, 3-(heptafluoroisopropoxy) propyltrichlorosilane, 3-(heptafluoroisopropoxy) propyltriethoxysilane, or perfluorooctyltriethoxysilane.

Other silanes can be used instead of, or in addition to, the phenylsilane or the fluorosilane, for example, aminosilanes and silanes containing polymerizable functional groups such as acryl and methacryl groups. Examples of aminosilanes include N-methyl-γ-aminopropyltriethoxysilane, N-ethyl-γ-aminopropyltrimethoxysilane, N-methyl-β-aminoethyltrimethoxysilane, γ-aminopropylmethyldimethoxysilane, N-methyl-γ-aminopropylmethyldimethoxysilane, N-(β-N-methylaminoethyl)-γ-aminopropyltriethoxysilane, N-(γ-aminopropyl)-γ-aminopropylmethyldimethoxysilane, N-(γ-aminopropyl)-N-methyl-γ-aminopropylmethyldimethoxysilane and γ-aminopropylethyldielhoxysilaneaminoethylamino trimethoxy silane, aminoethylamino propyl trimethoxy silane, 2-ethylpiperidinotrimethylsilane, 2-ethylpiperidinomethylphenylchlorosilane, 2-ethylpiperidinodimethylhydridosilane, 2-ethylpiperidinodicyclopentylchlorosilane, (2-ethylpiperidino) (5-hexenyl)methylchlorosilane, morpholinovinylmethylchlorosilane, n-methylpiperazinophenyldichlorosilane, or combinations comprising at least one of the foregoing.

Silanes including a polymerizable functional group include silanes of the formula R^{a}ₓSiR^{b}₍₃₋ₓ₎R, in which each R^{a} is the same or different (for example, the same) and is halogen (for example, Cl or Br), C₁₋₄ alkoxy (for example, methoxy or ethoxy), or C₂₋₆ acyl; each R^{b} is a C₁₋₈ alkyl or C₆₋₁₂ aryl (for example, R^{b} can be methyl, ethyl, propyl, butyl or phenyl); x is 1, 2 or 3 (for example, 2 or 3); and R is —(CH₂)ₙOC(=O)C(R^{c})=CH₂, wherein R^{c} is hydrogen or methyl and n is an integer 1 to 6, or, 2 to 4. The silane can comprise at least one of methacrylsilane (3-methacryloxypropyl trimethoxy silane) or trimethooxyphenylsilane.

The titanate coating can be formed from neopentyl(diallyl)oxy, trineodecanonyl titanate; neopentyl(diallyl)oxy, tri(dodecyl)benzene-sulfonyl titanate; neopentyl(diallyl)oxy, tri(dioctyl)phosphato titanate; neopentyl(diallyl)oxy, tri(dioctyl)pyro-phosphato titanate; neopentyl(diallyl)oxy, tri(N-ethylenediamino) ethyl titanate; neopentyl(diallyl)oxy, tri(m-amino)phenyl titanate; and neopentyl(diallyl)oxy, trihydroxy caproyl titanate; or a combination comprising at least one of the foregoing. The zirconate coating can be formed from neopentyl(diallyloxy)tri(dioctyl) pyro-phosphate zirconate, neopentyl(diallyoxy)tri(N-ethylenediamino) ethyl zirconate, or a combination comprising at least one of the foregoing.

The Co₂Y-type ferrite can be coated to a level of less than or equal to 10 wt %, or less than or equal to 5 wt %, or 0.1 to 5 wt %, or 0.1 to 3 wt % based on the total weight of the Co₂Y-type ferrite plus the coating.

The Co₂Y-type ferrite particles can be used to make a composite, for example, comprising the Co₂Y-type ferrite and a polymer. The polymer can comprise a thermoplastic or a thermoset. As used herein, the term “thermoplastic” refers to a material that is plastic or deformable, melts to a liquid when heated, and freezes to a brittle, glassy state when cooled sufficiently. Examples of thermoplastic polymers that can be used include cyclic olefin polymers (including polynorbornenes and copolymers containing norbornenyl units, for example, copolymers of a cyclic polymer such as norbornene and an acyclic olefin such as ethylene or propylene), fluoropolymers (for example, polyvinyl fluoride (PVF), polyvinylidene fluoride (PVDF), fluorinated ethylene-propylene (FEP), polytetrafluoroethylene (PTFE), poly(ethylene-tetrafluoroethylene (PETFE), or perfluoroalkoxy (PFA)), polyacetals (for example, polyoxyethylene or polyoxymethylene), poly(C₁₋₆ alkyl)acrylates, polyacrylamides (including unsubstituted and mono-N- or di-N-(C₁₋₈ alkyl)acrylamides), polyacrylonitriles, polyamides (for example, aliphatic polyamides, polyphthalamides, or polyaramides), polyamideimides, polyanhydrides, polyarylene ethers (for example, polyphenylene ethers), polyarylene ether ketones (for example, polyether ether ketones (PEEK) or polyether ketone ketones (PEKK)), polyarylene ketones, polyarylene sulfides (for example, polyphenylene sulfides (PPS)), polyarylene sulfones (for example, polyethersulfones (PES) or polyphenylene sulfones (PPS)), polybenzothiazoles, polybenzoxazoles, polybenzimidazoles, polycarbonates (including homopolycarbonates or polycarbonate copolymers such as polycarbonate-siloxanes, polycarbonate-esters, or polycarbonate-ester-siloxanes), polyesters (for example, polyethylene terephthalates, polybutylene terephthalates, polyarylates, or polyester copolymers such as polyester-ethers), polyetherimides (for example, copolymers such as polyetherimide-siloxane copolymers), polyimides (for example, copolymers such as polyimide-siloxane copolymers), poly(C₁₋₆ alkyl)methacrylates, polyalkylacrylamides (for example, unsubstituted and mono-N- or di-N-(C₁₋₈ alkyl)acrylamides), polyolefins (for example, polyethylenes, such as high density polyethylene (HDPE), low density polyethylene (LDPE), or linear low density polyethylene (LLDPE), polypropylenes, or their halogenated derivatives (such as polytetrafluoroethylenes), or their copolymers, for example, ethylene-alpha-olefin copolymers), polyoxadiazoles, polyoxymethylenes, polyphthalides, polysilazanes, polysiloxanes (silicones), polystyrenes (for example, copolymers such as acrylonitrile-butadiene-styrene (ABS) or methyl methacrylate-butadiene-styrene (MBS)), polysulfides, polysulfonamides, polysulfonates, polysulfones, polythioesters, polytriazines, polyureas, polyurethanes, vinyl polymers (for example, polyvinyl alcohols, polyvinyl esters, polyvinyl ethers, polyvinyl halides (for example, polyvinyl chloride), polyvinyl ketones, polyvinyl nitriles, or polyvinyl thioethers), a paraffin wax, or the like. A combination comprising at least one of the foregoing thermoplastic polymers can be used.

Thermoset polymers are derived from thermosetting monomers or prepolymers (resins) that can irreversibly harden and become insoluble with polymerization or cure, which can be induced by heat or exposure to radiation (e.g., ultraviolet light, visible light, infrared light, or electron beam (e-beam) radiation). Thermoset polymers include alkyds, bismaleimide polymers, bismaleimide triazine polymers, cyanate ester polymers, benzocyclobutene polymers, benzoxazine polymers, diallyl phthalate polymers, epoxies, hydroxymethylfuran polymers, melamine-formaldehyde polymers, phenolics (including phenol-formaldehyde polymers such as novolacs and resoles), benzoxazines, polydienes such as polybutadienes (including homopolymers or copolymers thereof, e.g., poly(butadiene-isoprene)), polyisocyanates, polyureas, polyurethanes, triallyl cyanurate polymers, triallyl isocyanurate polymers, certain silicones, and polymerizable prepolymers (e.g., prepolymers having ethylenic unsaturation, such as unsaturated polyesters, polyimides), or the like. The prepolymers can be polymerized, copolymerized, or crosslinked, e.g., with a reactive monomer such as styrene, alpha-methylstyrene, vinyltoluene, chlorostyrene, acrylic acid, (meth)acrylic acid, a (C₁₋₆ alkyl)acrylate, a (C₁₋₆ alkyl)methacrylate, acrylonitrile, vinyl acetate, allyl acetate, triallyl cyanurate, triallyl isocyanurate, or acrylamide.

The polymer can comprise at least one of paraffin wax, polytetrafluoroethylene, a polyethylene, a polypropylene, polyolefin, a polyurethane, a silicone polymer, a liquid crystalline polymer, poly(ether ether ketone), or poly(phenylene sulfide) (PPS). The polymer can comprise a fluoropolymer (for example, polytetrafluoroethylene (PTFE)). The polymer can comprise a poly(phenylene sulfide).

If the polymer comprises PTFE, powders of the PTFE and the Co₂Y-type ferrite can be blended together and then air milled. A commercially available example of an air mill is the Jet Pulverizer MICRON-MASTER mill. The air milled powders can allow for higher filler loadings without the article becoming brittle. Other energy intensive methods, such a blending in a Patterson Kelly vee-blender with an intensifier bar, can be used. The intensively mixed powders may then be compression molded.

The PTFE composite can be prepared by dispersion casting, for example, as described in U.S. Pat. No. 5,506,049 to G. S. Swei and D. J. Arthur. Dispersion casting can allow for the production of PTFE composites filled to higher than 60 vol % that still retain excellent flexibility. The films can be cast and then sintered on a carrier sheet to result in a free film or cast onto glass fabric to form a fabric reinforced composite sheet. The composite sheets can be used “as cast” as a dielectric load or stacked to a desired final thickness and densified in a press. The casting mixture can be made by dispersing the particles in water and combining the slurry with PTFE dispersion and stabilizing additives, and increasing the viscosity to keep the particles from settling.

The PTFE composite can be prepared by paste extrusion and calendering to result in flexible particulate-filled PTFE composites with filler contents in excess of 60 vol %. The ferrite filler can be dispersed in water, mixed with a PTFE dispersion and then co-coagulated with the PTFE to form a “dough.” As described in U.S. Pat. No. 4,518,787 to G. R. Traut, the dough can then be lubricated with a hydrocarbon liquid and extruded into a ribbon that can then calendered into sheets. Alternatively, the filler and PTFE “fine powder” (also known as “coagulated dispersion” PTFE) can be mixed and lubricated in a vee-blender, and then paste extruded and calendered. The lubricant can be removed and the sheets can be stacked to the desired basis weight and laminated in a flat bed press.

The Co₂Y-type ferrite composite can comprise 5 to 95 volume percent, or 50 to 80 volume percent, or 40 to 60 volume percent of the Co₂Y-type ferrite based on the total volume of the Co₂Y-type ferrite composite. The Co₂Y-type ferrite composite can comprise or 20 to 50 volume percent of the polymer based on the total volume of the Co₂Y-type ferrite composite. The Co₂Y-type ferrite composite can be formed by compression molding, injection molding, reaction injection molding, laminating, extruding, calendering, casting, rolling, or the like.

The composite can have a porosity. The porosity of the composite can be 0 to 45 volume percent, or 15 to 35 volume percent based on the total volume of the composite. Without intending to be bound by theory, it is believed that porosity of the composite can help lower the permittivity of the composite relative to the permeability. The porosity can be tuned by altering one or more of the calcining temperature or the particle size of the ferrite. Conversely, the composite can be free of a void space.

The Co₂Y-type ferrite can have a specific magnetic loss of less than or equal to 0.02, or less than or equal to 0.03, or less than or equal to 0.015, or 0.012 to 0.03 over the frequency range of 1 to 2 GHz or at 1.2 GHz.

The Co₂Y-type ferrite can have a permeability (μ′) of greater than or equal to 3, or 3 to 6, or 3 to 4 over the frequency range of 1 to 2 GHz or at 1.2 GHz. The composite can have a permeability of greater than or equal to 1.5, or 1.5 to 4, or 1.5 to 2 over the frequency range of 1 to 2 GHz or at 1.2 GHz.

The Co₂Y-type ferrite can have a magnetic loss (also referred to as magnetic loss tangent, tanδ_{μ}or μ″/μ′) of less than or equal to 0.75, or less than or equal to 0.5, or less than or equal to 0.09, or 0.07 to 0.2 over the frequency range of 1 to 2 GHz, or at 1.2 GHz. The composite can have a magnetic loss tangent of less than or equal to 0.1, or less than or equal to 0.03, or less than or equal to 0.02, or 0.015 to 0.1 over the frequency range of 1 to 2 GHz or at 1.2 GHz.

The Co₂Y-type ferrite can have a low specific loss defined by tanδ_{μ′}/μ′ or μ″/μ′². For example, the Co₂Y-type ferrite can have a low specific loss of 0.013 to 0.03 over the frequency range of 1 to 2 GHz.

The Co₂Y-type ferrite can have a permittivity (e) of less than or equal to 9, or 8 to 13 over the frequency range of 1 to 2 GHz or at 1.2 GHz. The composite can have a permittivity of 5 to 8 over the frequency range of 1 to 2 GHz or at 1.2 GHz, depending upon the polymer matrix.

The Co₂Y-type ferrite can have a dielectric loss (also referred to as dielectric loss tangent, tANδ_{ϵ}, or ϵ″/ϵ′) of less than or equal to 0.01, or 0.002 to 0.009 over the frequency range of 1 to 2 GHz or at 1.2 GHz. The composite can have a dielectric loss of less than or equal to 0.008, or less than or equal to 0.006, or 0.002 to 0.006 over the frequency range of 1 to 2 GHz or at 1.2 GHz.

As used herein, the phrase “at a frequency of” can mean at a single frequency value in that range or over the entire frequency range. For example, the phrase “the permeability can be 2 to 10 at a frequency of 0.5 to 3 gigahertz,” can mean that the permeability is a single value in the range of 2 to 10, for example, 3 at a single frequency in the range of 0.5 to 3, for example, at 1 gigahertz; or the permeability can be a value defined by the range of 2 to 10 (e.g. varying in this range with frequency) over the entire frequency range spanning from 0.5 to 3 gigahertz.

The magnetic and dielectric properties of the ferrites can be measured using a coaxial airline by vector network analyzer (VNA) in Nicholson-Ross-Weir (NRW) method over a frequency of 0.1 to 6 gigahertz.

The operating frequency of the Co₂Y-type ferrite can be as much as 6 gigahertz, or 0.5 to 2 gigahertz.

An article can comprise the Co₂Y-type ferrite. The article can be an antenna, for example, for GPS tracking. The article can be used for a variety of devices operable within the ultrahigh frequency range, such as a high frequency or microwave antenna, filter, inductor, circulator, or phase shifter. The article can be an antenna (for example, a patch antenna), a filter, an inductor, a circulator, or an EMI (electromagnetic interference) suppressor. Such articles can be used in commercial and military applications, weather radar, scientific communications, wireless communications, autonomous vehicles, aircraft communications, space communications, satellite communications, or surveillance.

The article can include a dielectric layer that comprises the composite; and a conductive layer. Useful conductive layers include, for example, stainless steel, copper, gold, silver, aluminum, zinc, tin, lead, transition metals, and alloys comprising at least one of the foregoing. There are no particular limitations regarding the thickness of the conductive layer, nor are there any limitations as to the shape, size, or texture of the surface of the conductive layer. The conductive layer can have a thickness of 3 to 200 micrometers, or 9 to 180 micrometers. When two or more conductive layers are present, the thickness of the two layers can be the same or different. The conductive layer can comprise a copper layer. Suitable conductive layers include a thin layer of a conductive metal such as a copper foil presently used in the formation of circuits, for example, electrodeposited copper foils. The copper foil can have a root mean squared (RMS) roughness of less than or equal to 2 micrometers, specifically, less than or equal to 0.7 micrometers, where roughness is measured using a Veeco Instruments WYCO Optical Profiler, using the method of white light interferometry.

The conductive layer can be applied by placing the conductive layer in the mold prior to molding the composite, by laminating conductive layer onto the composite (also referred to herein as the substrate), by direct laser structuring, or by adhering the conductive layer to the substrate via an adhesive layer. Other methods known in the art can be used to apply the conductive layer where permitted by the particular materials and form of the circuit material, for example, electrodeposition, chemical vapor deposition, and the like.

The laminating can entail laminating a multilayer stack comprising the substrate, a conductive layer, and an optional intermediate layer between the substrate and the conductive layer to form a layered structure. The conductive layer can be in direct contact with the substrate layer, without the intermediate layer. The layered structure can then be placed in a press, e.g., a vacuum press, under a pressure and temperature and for duration of time suitable to bond the layers and form a laminate. Lamination and optional curing can be by a one-step process, for example, using a vacuum press, or can be by a multi-step process. In a one-step process, the layered structure can be placed in a press, brought up to laminating pressure (e.g., 150 to 400 pounds per square inch (psi) (1 to 2.8 megapascal (MPa)) and heated to laminating temperature (e.g., 260 to 390 degrees Celsius (° C.)). The laminating temperature and pressure can be maintained for a desired soak time, i.e., 20 minutes, and thereafter cooled (while still under pressure) to less than or equal to 150° C.

If present, the intermediate layer can comprise a polyfluorocarbon film that can be located in between the conductive layer and the substrate layer, and an optional layer of microglass reinforced fluorocarbon polymer can be located in between the polyfluorocarbon film and the conductive layer. The layer of microglass reinforced fluorocarbon polymer can increase the adhesion of the conductive layer to the substrate. The microglass can be present in an amount of 4 to 30 weight percent (wt %) based on the total weight of the layer. The microglass can have a longest length scale of less than or equal to 900 micrometers, or less than or equal to 500 micrometers. The microglass can be microglass of the type as commercially available by Johns-Manville Corporation of Denver, Colorado. The polyfluorocarbon film comprises a fluoropolymer (such as polytetrafluoroethylene (PTFE), a fluorinated ethylene-propylene copolymer (such as Teflon FEP), or a copolymer having a tetrafluoroethylene backbone with a fully fluorinated alkoxy side chain (such as Teflon PFA)).

The conductive layer can be applied by laser direct structuring. Here, the substrate can comprise a laser direct structuring additive; and the laser direct structuring can comprise using a laser to irradiate the surface of the substrate, forming a track of the laser direct structuring additive, and applying a conductive metal to the track. The laser direct structuring additive can comprise a metal oxide particle (such as titanium oxide and copper chromium oxide). The laser direct structuring additive can comprise a spinel-based inorganic metal oxide particle, such as spinel copper. The metal oxide particle can be coated, for example, with a composition comprising tin and antimony (for example, 50 to 99 wt % of tin and 1 to 50 wt % of antimony, based on the total weight of the coating). The laser direct structuring additive can comprise 2 to 20 parts of the additive based on 100 parts of the respective composition. The irradiating can be performed with a yttrium aluminum garnet (YAG) laser having a wavelength of 1,064 nanometers under an output power of 10 Watts, a frequency of 80 kilohertz (kHz), and a rate of 3 meters per second. The conductive metal can be applied using a plating process in an electroless plating bath comprising, for example, copper.

The conductive layer can be applied by adhesively applying the conductive layer. The conductive layer can be a circuit (the metallized layer of another circuit), for example, a flex circuit. An adhesion layer can be disposed between one or more conductive layers and the substrate. When appropriate, the adhesion layer can comprise at least one of a poly(arylene ether) or a carboxy-functionalized polybutadiene or polyisoprene polymer comprising butadiene, isoprene, or butadiene and isoprene units, and 0 to 50 wt % of co-curable monomer units. The adhesive layer can be present in an amount of 2 to 15 grams per square meter. The poly(arylene ether) can comprise a carboxy-functionalized poly(arylene ether). The poly(arylene ether) can be the reaction product of a poly(arylene ether) and a cyclic anhydride or the reaction product of a poly(arylene ether) and maleic anhydride. The carboxy-functionalized polybutadiene or polyisoprene polymer can be a carboxy-functionalized butadiene-styrene copolymer. The carboxy-functionalized polybutadiene or polyisoprene polymer can be the reaction product of a polybutadiene or polyisoprene polymer and a cyclic anhydride. The carboxy-functionalized polybutadiene or polyisoprene polymer can be a maleinized polybutadiene-styrene or maleinized polyisoprene-styrene copolymer.

A Co₂ Y-type ferrite can comprise oxides of at least Ba, La, Co, Me, Fe, and optionally Ca; wherein Me is at least Ni and optionally one or more of Zn, Cu, Mn, or Mg. The Co₂Y-type ferrite can have a formula Ba₁₋ₓLaₓCaₙCo_{2-y-z}Me_{y}Fe₁₂₋ₘO₂₂, wherein x is 0.01 to 0.5, or 0.1 to 0.5; y is 0.01 to 1.5, or 0.1 to 1, or 0.2 to 0.5; z is −0.5 to 0.5, or −0.2 to 0; and m is −2 to 2, or 0.1 to 0.5; n is 0 to 0.5; or 0.01 to 0.5. The Co₂Y-type ferrite can have a formula Ba₁₋ₓLaₓCaₙCo_{2-y-z}Ni_{y}Fe₁₂₋ₘO₂₂. The Co₂Y-type ferrite can have a D₅₀ particle size of 2 to 10 micrometers. The Co₂Y-type ferrite can have a porosity of 0 to 50 volume percent, or 20 to 45 volume percent based on the total volume of the Co₂Y-type ferrite. The Co₂Y-type ferrite can have a permeability greater than or equal to 3, or 3 to 6, or 3 to 4 over the frequency range of 1 to 2 GHz or at 1.2 GHz. The Co₂Y-type ferrite can have a magnetic loss of less than or equal to 0.75, or less than or equal to 0.5, or less than or equal to 0.09, or 0.07 to 0.2 over the frequency range of 1 to 2 GHz, or at 1.2 GHz. The Co₂Y-type ferrite can have a permittivity of less than or equal to 9, or 8 to 9 over the frequency range of 1 to 2 GHz or at 1.2 GHz. The Co₂Y-type ferrite can have a dielectric loss of less than or equal to 0.01, or 0.002 to 0.009 over the frequency range of 1 to 2 GHz or at 1.2 GHz.

A composite comprising a polymer and the Co₂Y-type ferrite. The polymer can comprise at least one of a paraffin wax, polytetrafluoroethylene, a polyethylene, a polypropylene, polyolefin, a polyurethane, a silicone polymer, a liquid crystalline polymer, poly(ether ether ketone), or poly(phenylene sulfide). The polymer can comprise polytetrafluoroethylene or poly(phenylene sulfide). The composite can have a permeability of greater than or equal to 1.5, or 1.5 to 4, or 1.5 to 2 over the frequency range of 1 to 2 GHz or at 1.2 GHz. The composite can have a specific magnetic loss of less than or equal to 0.02, or less than or equal to 0.03, or less than or equal to 0.015, or 0.012 to 0.03 over the frequency range of 1 to 2 GHz or at 1.2 GHz. The composite can have a permittivity of less than or equal to 6.5, or 5 to 6.5 over the frequency range of 1 to 2 GHz or at 1.2 GHz. The composite can have a dielectric loss of less than or equal to 0.008, or less than or equal to 0.006, or 0.002 to 0.006 over the frequency range of 1 to 2 GHz or at 1.2 GHz. The composite can comprise 5 to 95 volume percent, or 50 to 80 volume percent, or 40 to 60 volume percent of the Co₂Y-type ferrite based on the total volume of the composite. The composite can have a porosity of 0 to 45 volume percent, or 15 to 35 volume percent based on the total volume of the composite.

An article comprising the ferrite composition or the composite. The article can be an antenna.

A method of making a Co₂Y-type ferrite can comprise milling ferrite precursor compounds comprising oxides of at least Ba, La, Co, Me, and Fe, wherein Me includes Ni and optionally another divalent element such as one or more of Zn, Cu, Mn, or Mg to form a magnetic oxide mixture; and calcining the magnetic oxide mixture in an oxygen or air atmosphere to form the Co₂Y-type ferrite. The calcining the mixed ferrite can occur at a calcining temperature of 800 to 1,300° C., or 900 to 1,250° C. The calcining the mixed ferrite can occur for a calcining time of 0.5 to 20 hours, or 1 to 10 hours. The method can further comprise forming a composite comprising the Co₂Y-type ferrite and a polymer.

The following examples are provided to illustrate the present disclosure. The examples are merely illustrative and are not intended to limit devices made in accordance with the disclosure to the materials, conditions, or process parameters set forth therein.

### EXAMPLES

The magnetic permeability and the magnetic loss of the ferrites were measured in the coaxial airline by vector network analyzer (VNA) in Nicholson-Ross-Weir (NRW) method over a frequency of 0.1 to 6 gigahertz (GHz).

The Co₂ Y-type ferrite formulations used in the examples are listed below as Formulations 1-3.

Ba₁₋₉La_{0.1}Co_{1.6}Zn_{0.4}Fe_{11.8}O₂₂ Formulation I:

Ba₁₋₉La_{0.1}Co_{1.4}Ni_{0.4}Zn_{0.4}Fe_{11.7}O₂₂ Formulation II:

Ba₁₋₉La_{0.1}Ca_{0.1}Co_{1.4}Ni_{0.4}Zn_{0.4}Fe_{11.7}O₂₂ Formulation III:

### Examples 1-5: Effect of the Nickel on the Magnetic Properties on the Co₂Y-type Ferrite in a Paraffin Wax

The Co₂Y ferrites were prepared by mixing BaCO₃ (99.9%), CaCO₃ (99.5%), Co₃O₄ (99.9%), La₂O₃ (99.9%), NiO (99%), ZnO (99.9%), and Fe₂O₃ (99.4%) in amounts to form the ferrites of formulations 1-3. The oxide mixtures were mixed in a wet-planetary ball mill for two hours at 350 revolutions per minute (rpm), dried in an oven at 100° C., and screened through 40# sieve to form coarse particles. The coarse particles were then calcined at a temperature of 1,030° C. for a soak time of 4 hours in air to form the Co₂Y ferrite having the formula Ba0.9La_{0.1}Co_{2-x-y-z}CaₙNiₓZn_{y}Fe₁₂₋ₘO₂₂. The Co₂Y ferrite was then jaw crushed and ground in stainless steel jars for 3 minutes in planetary ball mill at 350 rpm, and finally sieved through 40# screen and then through a 200# screen. The ferrite particles had a D₅₀ particle size by volume of 2 to 6 micrometers. The Co₂Y ferrites were then mixed with paraffin wax to form composites comprising 25 to 45 vol % of the Co₂Y ferrite.

TABLE 1

| | Ferrite | Ferrite | | Frequency (GHz) | | | |
|---|---|---|---|---|---|---|---|
| Example | formulation | (vol %) | Property | 1 | 1.2 | 1.6 | 2 |
| 1 | I | 45 | μ′ | 1.590 | 1.587 | 1.585 | 1.616 |
| | | | μ″/μ′ | 0.026 | 0.034 | 0.047 | 0.050 |
| | | | μ″/μ′² | 0.016 | 0.021 | 0.030 | 0.031 |
| | | | ε′ | 5.810 | 5.814 | 5.815 | 5.804 |
| | | | ε″/ε′ | 0.008 | 0.006 | 0.005 | 0.009 |
| 2 | II | 45 | μ′ | 1.610 | 1.608 | 1.614 | 1.642 |
| | | | μ″/μ′ | 0.022 | 0.031 | 0.044 | 0.046 |
| | | | μ″/μ′² | 0.014 | 0.019 | 0.027 | 0.028 |
| | | | ε′ | 5.690 | 5.693 | 5.695 | 5.692 |
| | | | ε″/ε′ | 0.008 | 0.006 | 0.005 | 0.009 |
| 3 | III | 45 | μ′ | 1.810 | 1.814 | 1.824 | 1.852 |
| | | | μ″/μ′ | 0.029 | 0.034 | 0.040 | 0.060 |
| | | | μ″/μ′² | 0.016 | 0.019 | 0.022 | 0.032 |
| | | | ε′ | 6.012 | 6.018 | 6.031 | 6.016 |
| | | | ε″/ε′ | 0.004 | 0.004 | 0.007 | 0.008 |
| 4 | III | 25 | μ′ | 1.433 | 1.431 | 1.433 | 1.458 |
| | | | μ″/μ′ | 0.022 | 0.027 | 0.040 | 0.039 |
| | | | μ″/μ′² | 0.015 | 0.019 | 0.028 | 0.027 |
| | | | ε′ | 4.032 | 4.037 | 4.043 | 4.039 |
| | | | ε″/ε′ | 0.006 | 0.005 | 0.002 | 0.008 |
| 5 | III | 30 | μ′ | 1.508 | 1.506 | 1.511 | 1.525 |
| | | | μ″/μ′ | 0.020 | 0.028 | 0.044 | 0.044 |
| | | | μ″/μ′² | 0.013 | 0.019 | 0.029 | 0.029 |
| | | | ε′ | 4.426 | 4.429 | 4.436 | 4.444 |
| | | | ε″/ε′ | 0.008 | 0.006 | 0.003 | 0.009 |

Table 1 shows that Examples 2-5 have specific magnetic loss values of 0.014 -to 0.028, values that are lower than that (0.016-0.031) of Example 1.

### Examples 6-8: Effect of the Nickel on the Magnetic Properties on the Co₂Y-type Ferrite in PPS

A 50 cubic centimeter dual Banbury rotor mixing bowl was attached to the drive of a Brabender Intelli-Torque Plasti-Corder torque rheometer. The bowl heaters were set to a temperature of 315° C. The rotor speed was set at a speed of 75 rpm. The mixer body temperature was heated until it reached steady state. 29.6 grams (g) of polyphenylene sulfide (PPS) (SOLVAY QA321) and 96.4 g of ferrite powders were weighed out separately. Half of the ferrite was hand blended with the PPS and the other half was set aside. The rotors were started, and the machine calibrated the torque for the unfilled chamber. After calibration, the PPS-ferrite powder was slowly loaded, and the powders were allowed to flux into a melt. The remaining ferrite powder was fed into the melt and mixed for 4 minutes. The torque at 4 minutes was 1126 milligrams and the temperature was 336° C. At the end of the run, the torque rheometer was stopped and disassembled to remove the melt of the composite material in teaspoon sized chunks (aka fossils) and allowed to cool.

The 25 square inch platens of a Carver hydraulic lab press were electrically heated 310° C. A volume of compound fossils was placed into the cavity of a metal mold. When the platens reached temperature, the mold was inserted into the press and allowed to heat up under minimal pressure for 1 to 2 minutes before pressures of 10,000 pounds per square inch (psi) were applied to the press ram for full compaction. The mold was allowed to stay under pressure for 1 to 2 minutes before the heat was shut off and cooling air was circulated through the platens. When the platen temperatures were below 30° C., the pressure on the ram was released. The mold was removed from the press and the part was extracted from the mold, followed by cutting into a toroid for electromagnetic measurement.

TABLE 2

| | Ferrite | Ferrite | | Frequency (GHz) | | | |
|---|---|---|---|---|---|---|---|
| Example | formulation | (vol %) | Property | 1 | 1.2 | 1.6 | 2 |
| 6 | I | 45 | μ′ | 1.456 | 1.449 | 1.437 | 1.462 |
| | | | μ″/μ′ | 0.028 | 0.035 | 0.047 | 0.045 |
| | | | μ″/μ′² | 0.019 | 0.024 | 0.033 | 0.030 |
| | | | ε′ | 7.014 | 7.022 | 7.035 | 7.018 |
| | | | ε″/ε′ | 0.007 | 0.005 | 0.004 | 0.008 |
| 7 | II | 45 | μ′ | 1.449 | 1.442 | 1.439 | 1.448 |
| | | | μ″/μ′ | 0.022 | 0.029 | 0.042 | 0.043 |
| | | | μ″/μ′² | 0.015 | 0.020 | 0.029 | 0.029 |
| | | | ε′ | 7.391 | 7.369 | 7.347 | 7.329 |
| | | | ε″/ε′ | 0.061 | 0.054 | 0.046 | 0.044 |
| 8 | III | 45 | μ′ | 1.471 | 1.467 | 1.468 | 1.473 |
| | | | μ″/μ′ | 0.018 | 0.027 | 0.043 | 0.049 |
| | | | μ″/μ′² | 0.013 | 0.018 | 0.029 | 0.033 |
| | | | ε′ | 6.517 | 6.517 | 6.520 | 6.522 |
| | | | ε″/ε′ | 0.023 | 0.019 | 0.015 | 0.016 |

Table 2 shows that Example 6 has specific magnetic loss (μ″/μ′²) of 0.024 at 1.2 GHz, whereas Examples 7 and 8 have significantly lower specific magnetic loss values of 0.020 and 0.018, respectively. The behavior reveals at the frequency from 1-1.6 GHz.

### Examples 9-11: Effect of the Nickel on the Magnetic Properties on the Co₂Y-type Ferrite in PTFE

Before incorporating the ferrite powders into the PTFE, the powders were pretreated with a 3:1 by weight mixture of an aromatic alkoxysilane (phenyl-trimethoxy silane) and fluorinated aliphatic alkoxysilane ((tridecafluoro-1,1,2,2-tetrahydrooctyl)triethoxy silane). The silane was applied at a level of 2.0 weight percent (wt %) based on the total weight of ferrite powder. The silane treatment was applied to approximately 300 grams of ferrite for each sample and mixed in a Flaktek Speedmixer for 15 seconds at 2,500 rpm. The sample jar was removed from the mixed and scraped with a spatula and remixed again for 15 seconds at 2,500 rpm. The samples were cured in an oven for five hours at 500° F. (260° C.).

The PTFE composite samples were prepared with DYNEON 2029Z PTFE fine powder resin. For the 45 volume percent loading, 66.9 wt % of the treated filler was blended with 33.1 wt % PTFE powder (on a dry solids basis) and mixed for 15 seconds at 2,500 rpm on the Flaktek mixer. The jar was removed and 21 wt % of dipropylene glycol (DPG) on a total mix weight basis was added and stirred with a spatula. The lubricated crumb was mixed on the FLAKTEK for 15 seconds at 2,500 rpm, removed, and stirred with a spatula and once again mixed on the Flaktek at the same conditions.

The lubricated crumb was pressed in a 7 centimeters (cm)×7 cm rectangular three part mold to form a 7 cm×7 cm x approximately 7 millimeters (mm) billet. The billet was calendered to form and approximate 0.7 mm sheet on a FARRELL LABORATORY CALENDER with the rolls heated to 50° C. The sheets were soaked in warm water to remove the DPG lubricant and baked for 16 hours at 500° F. (260° C.).

The dried sheets were trimmed to 7 centimeters (cm)×7 cm and placed in the three part mold. The sheets were laminated together in the mold in a 6 inch×6 inch (15.2 cm×16.2 cm) laboratory CARVER PRESS at a total force of 7,500 pounds per square inch (51.7 megapascals (MPa)) and a soak time of 45 minutes at 345° C.

TABLE 3

| | Ferrite | Ferrite | | Frequency (GHz) | | | |
|---|---|---|---|---|---|---|---|
| Example | formulation | (vol %) | Property | 1 | 1.2 | 1.6 | 2 |
| 9 | 1 | 45 | μ′ | 1.640 | 1.635 | 1.636 | 1.649 |
| | | | μ″/μ′ | 0.022 | 0.027 | 0.040 | 0.047 |
| | | | μ″/μ′² | 0.014 | 0.017 | 0.025 | 0.029 |
| | | | ε′ | 5.812 | 5.822 | 5.832 | 5.831 |
| | | | ε″/ε′ | 0.004 | 0.003 | 0.002 | 0.004 |
| 10 | 2 | 45 | μ′ | 1.595 | 1.592 | 1.596 | 1.609 |
| | | | μ″/μ′ | 0.021 | 0.027 | 0.042 | 0.050 |
| | | | μ″/μ′² | 0.013 | 0.017 | 0.026 | 0.031 |
| | | | ε′ | 5.647 | 5.654 | 5.661 | 5.663 |
| | | | ε″/ε′ | 0.009 | 0.007 | 0.005 | 0.008 |
| 11 | 3 | 45 | μ′ | 1.615 | 1.615 | 1.624 | 1.636 |
| | | | μ″/μ′ | 0.022 | 0.028 | 0.042 | 0.056 |
| | | | μ″/μ′² | 0.014 | 0.017 | 0.026 | 0.034 |
| | | | ε′ | 5.008 | 5.014 | 5.015 | 5.018 |
| | | | ε″/ε′ | 0.011 | 0.010 | 0.008 | 0.009 |

Table 3 shows that the Co₂Y-type ferrite maintains a low specific magnetic loss (0.013-0.03) over a frequency of 1 to 2 GHz.

### Example 3: Co₂Y-type Ferrite

Co₂Y-type ferrite particles were prepared in accordance with Example 1 to arrive at the ferrite of Formulation II. The Co₂Y-type ferrite powder was mixed with a 10 wt % poly(vinyl alcohol) solution and then sieved through 40# screen to form granules. The granules were pressed into a toroid under 1,800 pounds and the green body was sintered at 1,200° C. for two hours in a tube furnace with oxygen flowing at a rate of 0.5 liters per minute. The sintered toroid had the following dimensions: an outer diameter of 7 millimeters (mm), an inner diameter of 3 mm, and a height of 3 to 4 mm. The porous ceramic had a relative density of about 78%.

The magneto dielectric properties of the samples were determined over a frequency of 0.1 to 18 GHz and the results are shown in Table 4.

TABLE 4

| | 1.2 GHz | 1.6 GHz |
|---|---|---|
| μ′ | 3.39 | 3.44 |
| μ″/μ′ | 0.088 | 0.133 |
| ε′ | 8.78 | 8.79 |
| ε″/ε′ | 0.006 | 0.08 |

The data shows that the Co₂Y-type ferrite has a very low magnetic loss of less than or equal to 0.09 at 1.2 GHz, while retaining permeability of more than 3. Additionally, the Co₂Y-type ferrite has a dielectric constant is below 9 while maintaining a low dielectric loss of less than or equal to 0.006 at 1.2 GHz. The also data shows that the Co₂Y-type ferrite has a very low magnetic loss of less than or equal to 0.15 at 1.6 GHz, while retaining permeability of more than 3. Additionally, the Co₂Y-type ferrite has a dielectric constant is below 9 while maintaining a low dielectric loss of less than or equal to 0.008 at 1.6 GHz.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

As used herein, “a,” “an,” “the,” and “at least one” do not denote a limitation of quantity, and are intended to cover both the singular and plural, unless the context clearly indicates otherwise. For example, “an element” has the same meaning as “at least one element,” unless the context clearly indicates otherwise. The term “combination” is inclusive of blends, mixtures, alloys, reaction products, and the like. Also, “at least one of” means that the list is inclusive of each element individually, as well as combinations of two or more elements of the list, and combinations of at least one element of the list with like elements not named.

The term “or” means “and/or” unless clearly indicated otherwise by context. Reference throughout the specification to “an aspect”, “another aspect”, “some aspects”, and so forth, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” such as 10 to 23 wt %, etc.

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A Co₂Y-type ferrite, comprising:
oxides of at least Ba, La, Co, Me, Fe, and optionally Ca;
wherein Me is at least Ni and optionally one or more of Zn, Cu, Mn, or Mg.

2. The Co₂Y-type ferrite of claim 1, wherein the Co₂Y-type ferrite has a formula Ba₁₋ₓLaₓCaₙCo_{2-y-z}Me_{y}Fe₁₂₋ₘO₂₂, wherein x is 0.01 to 0.5, or 0.1 to 0.5; y is 0.01 to 1.5, or 0.1 to 1, or 0.2 to 0.5; z is −0.5 to 0.5, or −0.2 to 0; and m is −2 to 2, or 0.1 to 0.5; n is 0 to 0.5; or to 0.5.

3. The Co₂Y-type ferrite of claim 2, wherein the Co₂Y-type ferrite has a formula Ba₁₋ₓLaₓCaₙCo_{2-y-z}Ni_{y}Fe₁₂₋ₘO₂₂.

4. The Co₂Y-type ferrite of claim 1, wherein the Co₂Y-type ferrite has a D₅₀ particle size of 2 to 10 micrometers.

5. The Co₂Y-type ferrite of claim 1, wherein the Co₂Y-type ferrite has a porosity of 0 to 50 volume percent based on the total volume of the Co₂Y-type ferrite.

6. The Co₂Y-type ferrite of claim 1, wherein the Co₂Y-type ferrite has a permeability greater than or equal to 3 over the frequency range of 1 to 2 GHz.

7. The Co₂Y-type ferrite of claim 1, wherein the Co₂Y-type ferrite has a magnetic loss of less than or equal to 0.75 over the frequency range of 1 to 2 GHz.

8. The Co₂Y-type ferrite of claim 1, wherein the Co₂Y-type ferrite has a permittivity of less than or equal to 9 over the frequency range of 1 to 2 GHz.

9. The Co₂Y-type ferrite of claim 1, wherein the Co₂Y-type ferrite has a dielectric loss of less than or equal to 0.01 over the frequency range of 1 to 2 GHz.

10. A composite comprising a polymer and the Co₂Y-type ferrite of claim 1.

11. The composite of claim 10, wherein the polymer comprises at least one of a paraffin wax, polytetrafluoroethylene, a polyethylene, a polypropylene, polyolefin, a polyurethane, a silicone polymer, a liquid crystalline polymer, poly(ether ether ketone), or poly(phenylene sulfide).

12. The composite of claim 10, wherein the polymer comprises polytetrafluoroethylene or poly(phenylene sulfide).

13. The composite of claim 10, wherein the composite has at least one of
a permeability of greater than or equal to 1.5 over the frequency range of 1 to 2 GHz;
a specific magnetic loss of less than or equal to 0.03 over the frequency range of 1 to 2 GHz;
a permittivity of less than or equal to 6.5 over the frequency range of 1 to 2 GHz; or
a dielectric loss of less than or equal to 0.008 over the frequency range of 1 to 2 GHz.

14. The composite of claim 10, wherein the composite comprises 5 to 95 volume percent of the Co₂Y-type ferrite based on the total volume of the composite.

15. A composite of claim 10, wherein the composite has a porosity of 0 to 45 volume percent based on the total volume of the composite.

16. An article comprising the ferrite composition of claim 1.

17. The article of claim 16, wherein the article is an antenna.

18. A method of making a Co₂Y-type ferrite comprising:
milling ferrite precursor compounds comprising oxides of at least Ba, La, Co, Me, and Fe, wherein Me includes Ni and optionally another divalent element to form a magnetic oxide mixture; and
calcining the magnetic oxide mixture in an oxygen or air atmosphere to form the Co₂Y-type ferrite.

19. The method of claim 18, wherein the calcining the mixed ferrite occurs at a calcining temperature of 800 to 1,300° C. or for a calcining time of 0.5 to 20 hours.

20. The method of claim 18, further comprising forming a composite comprising the Co₂Y-type ferrite and a polymer.
